(19) United States
(12) Patent Application Publication
(10) Pub. No.: US 2003/0122775 A1
(43) Pub. Date: Jul. 3, 2003

(54) Apparatus for controlling and selecting display content of a wireless device

(76) Inventor: Raymond a.k.a. Hwei-Ming Ti, Richmind (CA)

Correspondence Address: Brian Rivers, Patent Department, % Milan Patel, Nokia Mobile Phones, 6000 Connection Drive, Irving, TX, 75039, US

(21) Appl. No.: 10/033,139

(22) Filed: Dec. 27, 2001

(51) Int. Cl. G09G 5/00; G09G 5/08

(52) U.S. Cl. 345/156; 345/158; 345/163

(57) ABSTRACT

An electronic device capable of scrolling and selecting content information exhibited within a display. The electronic device having a housing comprising at least two elements, where the first element contains the display and the second element is used to control scrolling and selection of content information within the display. The user can manipulate the second element in a translational or rotational motion to scroll and select content information within the display.

### FIELD OF THE INVENTION

The present invention relates to an apparatus for scrolling and selecting content information of a wireless device display, more particularly to a housing having at least two elements wherein one of the elements can be manipulated to scroll through and select content information on the display.

### BACKGROUND OF THE INVENTION

A communication system is operable to communicate information between a transmitting station, also referred to as a calling party, and a receiving station, also referred to as a receiving or called party, by way of a communication network. Operation of a wireless communication system transfers information between the transmitting and receiving stations via one or more base stations. These transmitting and receiving stations are also known as electronic devices, wireless communication devices, cell phones, mobile terminals or mobile phones, Personal Digital Assistants (PDA's), or portable computers. As the capability and sophistication of the wireless communication system has increased, the proliferation of data services for mobile communication devices has led to widespread use of the internet and high data volume software. Consequently, the capability to easily navigate several pages of text or content information exhibited in the display is becoming a very useful attribute for users. Larger displays are becoming more common among the latest mobile terminals to help facilitate the user with some perspective when viewing web pages or large documents, but an ergonomically efficient design to assist the user in scrolling and selecting information would further assist the user. Improvements in display navigation capability of the wireless communication device would address this new step to data weighted content information.

It would be useful to provide a housing, or enclosure, for an electronic device capable of operation within a wireless network to assist the user in scrolling and selecting content information within the display. In addition, the enclosure should be ergonomically pleasing to the user while accomplishing the aforementioned scrolling and selecting of display content information on the mobile communication device.

### SUMMARY OF THE INVENTION

The present invention encompasses a housing having at least a first and a second element for providing scrolling and selecting capability to an electronic device operable within a wireless communication system, such as a mobile station, a personal digital assistant (PDA) or a portable computer. The apparatus of the present invention comprises a housing to enclose the internal electronics in addition to providing contact and communication between the first and the second elements. Furthermore, the enclosure may comprise several modes for accomplishing the scrolling and selecting function to include translational (also known as parallel or linear), rotational (also referred to as pitch and yaw) or twisting (also referred to as roll) motion between the elements and/or the use of a switch to select content information on the display. The housing may provide operation by either a right-handed or a left-handed user according to orientation of the elements. A more complete appreciation of all the advantages and scope of the present invention can be obtained from the accompanying drawings, the following detailed description of the invention and the appended claims.

### BRIEF DESCRIPTION OF THE DRAWINGS

FIG. 1 illustrates a block diagram of a mobile terminal into which an embodiment of the invention may be implemented;

FIG. 2a is a top view of an electronic device illustrating an embodiment of the present invention.

FIG. 2b is a block diagram of several pages of display content information within a mobile terminal of an embodiment of the invention.

FIG. 2c is a block diagram of one page of display content information within a mobile terminal of an embodiment of the invention.

FIG. 3 is a front view of the electronic device illustrating an embodiment of the present invention.

FIG. 4 is a top view of an electronic device illustrating an alternative embodiment of the present invention.

FIG. 5 is a top view of the electronic device illustrating an alternative embodiment of the present invention.

FIG. 6 is a top view of an electronic device illustrating an alternative embodiment of the present invention.

FIG. 7 is a top view of an electronic device illustrating an alternative embodiment of the present invention.

### DETAILED DESCRIPTION OF THE INVENTION

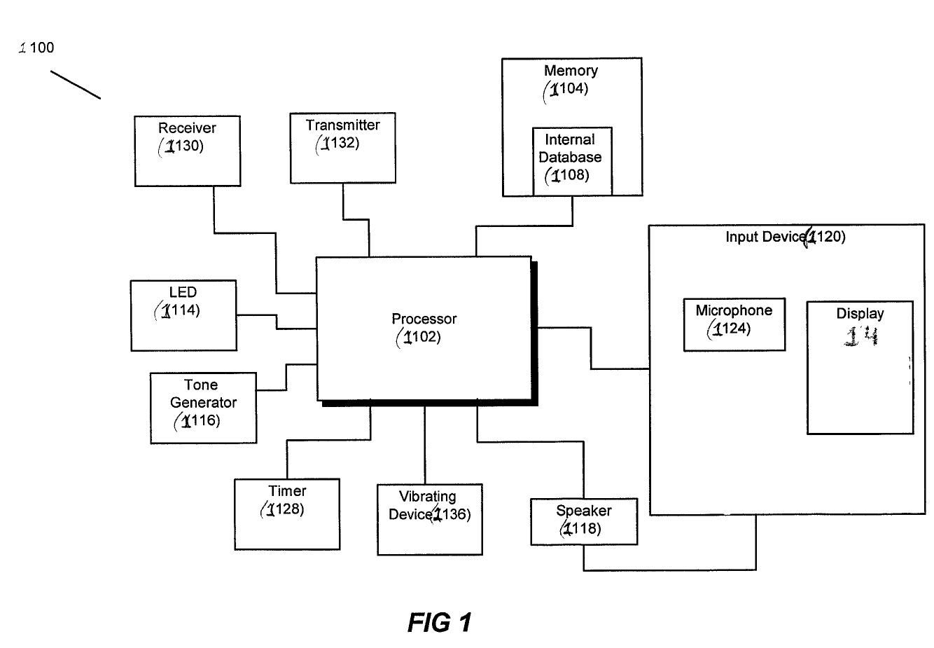

FIG. 1 is a block diagram of an electronic device, such as a mobile terminal 1100, according to an embodiment of the invention. The mobile terminal 1100 is operable in a wireless communication system (for example CDMA, TDMA, GSM, etc.). Generally, the mobile terminal 1100 includes a processor 1102 (which may also be known as a controller) coupled to various memories, collectively shown as memory 1104. Memory 1104 includes a plurality of stored constants and variables that are used by processor 1102 during the operation of the electronic device 1100. For example, the memory 1104 stores the values of the various feature parameters and the Number Assignment Module (NAM); furthermore, the memory 1104 also comprises an internal database 1108, for storing position parameters, profile settings of the electronic device, zone parameters and sector information. An operating program (not shown) for controlling the operation of processor 1102 is also stored in memory 1104 (typically in a read only memory). Memory 1104 is also used to store data provided by the user through the user interface. Furthermore, memory 1104 is used to hold the subprograms or sub-processes for controlling the operation of mobile terminal 1100 and carrying out an embodiment of the present invention.

The user interface of the mobile terminal 1100 also includes a display 14, Light Emitting Diode (LED) 1114, tone generator 1116, speaker 1118 and user input device 1120, all of which are coupled to the processor 102. The input device 1120 may also comprise a microphone 1124 in addition to the display 14. Mobile terminal 1100 also comprises timer 1128 (also referred to as a clock chip) coupled to the processor 1102 for synchronizing the operations of processor 1102 and tracking time.

The exemplary mobile terminal 1100 also includes a receiver 1130 coupled to an antenna 1136 for receiving incoming signals, and a transmitter 1132 for transmitting outgoing signals, both are coupled to the processor 1102. The processor 1102, coupled to the transmitter 1132 and the receiver 1130, initiates the transmission of outgoing signals and processes incoming signals, respectively. These signals may include signaling information in accordance with the air interface of the applicable cellular or digital system and also user speech and/or user generated data. The outgoing signals may be used to request data from external databases and the incoming signals may include position information and geographical zone parameters.

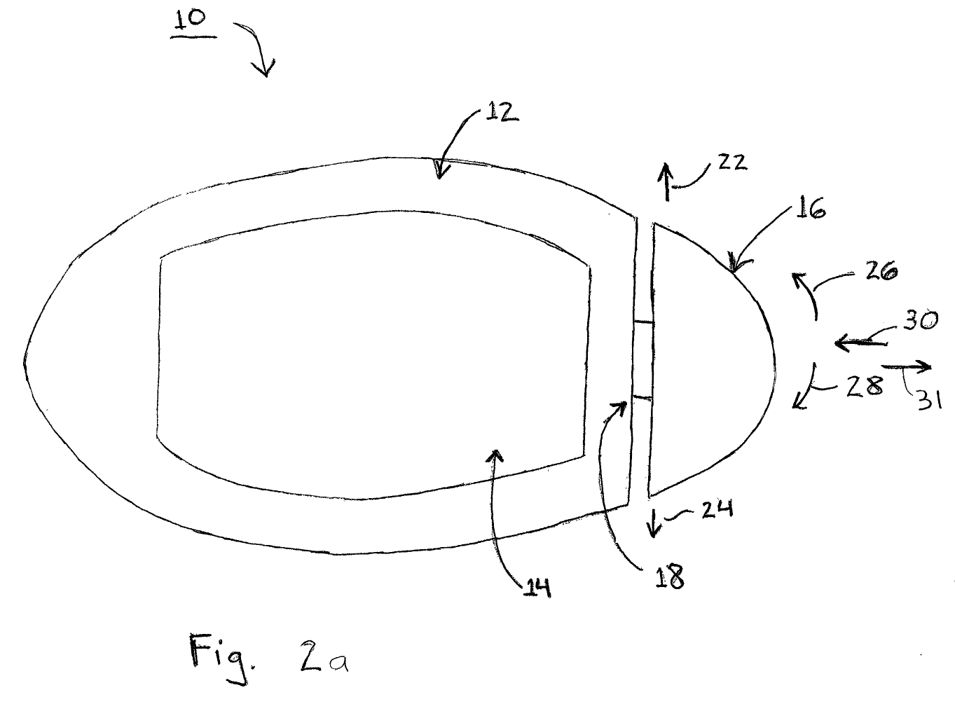

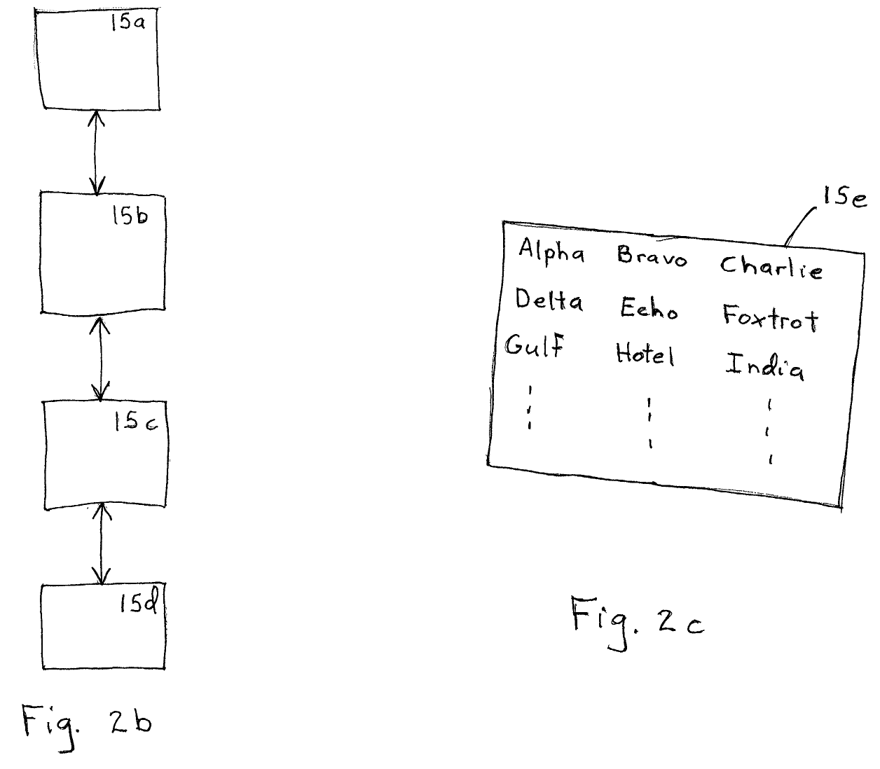

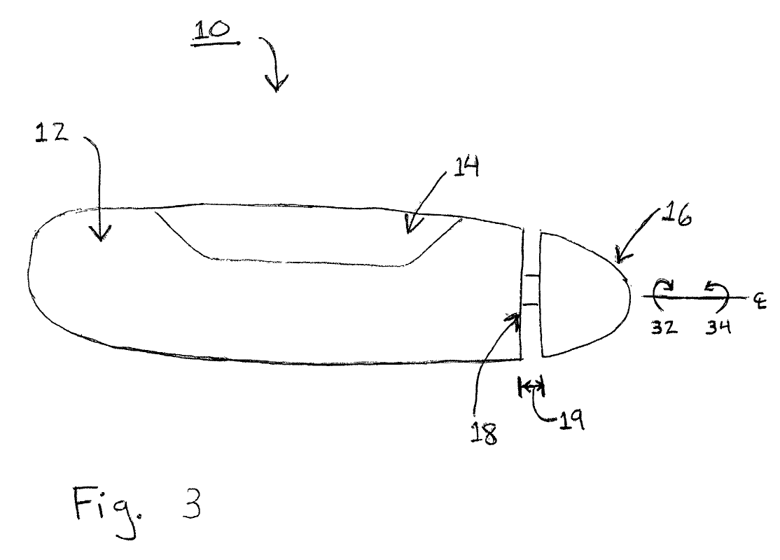

FIG. 2a is a top view of an electronic device 10 capable of operating within a wireless communication system. Generally, the electronic device 10 comprises a first element 12, a second element 16, the display 14 and a connector 18, where combination of these elements 14 and 16 provide an exterior, or housing, for the electronic device 10. As the transmission of content information, for example web pages, audio/video files and games, has increased; so has the need for the larger display 14, which enables the user to view many lines of content information, and maintain continuity while reading this content information.

In an exemplary implementation of the invention, the display 14 is provided on the first element 12. The display 14 may be a Liquid Crystal Display (LCD) or any number of known display devices. The display 14 coupled to the processor 1102 and used for displaying the content information, such as the web pages or phone numbers. The connector 18, coupled to processor 1102, provides communication between the first element 12 and the second element 16 of the electronic device 10. To facilitate scrolling through the content information, for example a web page, the user can manipulate the first element 12 or the second element 16, via translational (i.e. parallel or linear ) motion or rotational motion. The user may move the second element 16 opposite in relation to the first element 12, or the first element 12 opposite in relation to the second element 16, in translational direction 22 to scroll through the content information within the display 14. For example, the user may move the second element 16 downward to scroll downward within the content information, or alternatively the user may move the second element 16 downward, or the first element 12 upward, to scroll to the right hand side of the content information. In another operation of the embodiment, the user may rotate the second element 16 in a clockwise direction, or first element 12 in a counter clockwise direction, to scroll downward within the content information. Content information can include multiple pages of text, for example a Microsoft® Word or Excel file, multiple web pages and lists where navigation up/down, left/right is an important feature for the user.

The user may move the second element 16 in relation to the first element 12, or the first element 12 in relation to the second element 16 in rotational direction 26 or 28 to scroll left or right, respectively, through content information within the display 14. Selection of content information within the display 14 may be accomplished by moving the second element 16 in a translational direction 30 toward the first element 12, or the first element 12 in a translational direction 31 toward the second element 16.

The connector 18 provides physical interaction between the first and second elements, 12 and 16 respectively, in addition to a flexible communication link allowing relative motion between the first elements 12 and 16 to scroll and/or select content information within the display 14. Flexibility and durability are useful attributes allowing the connector 18 to undergo repeated manipulation cycles and maintain function and integrity. Any number of connectors well known to those skilled in the art may be used in the present invention, such as slide contacts, ball in socket contacts, or various electrical or mechanical contacts.

In an exemplary implementation, the first element 12 generally forms a major portion of the housing wherein the first element 12 generally contains the display 14. The second element 16 forms a minor portion of the housing where the second element 16 is an activating portion for scrolling/selecting content information within the display 14. The first element 12 can contain components outlined in FIG. 1, such as the processor 1102, receiver 1130, transmitter 1132, memory 1104, input device 1120 and speaker 1118.

FIG. 2b is a block diagram of pages 15a-d of content information within the display 14, where the user may scroll upward, for example starting at 15c and progressing to 15b followed by 15a, or downward to 15d. FIG. 2c illustrates a single page of content information 15e where the user may navigate left/right or up/down and select a single name from a list. For example, starting at Echo the user may scroll upward to Bravo and right to Charlie and then select Charlie from the list.

FIG. 3 is a front view of the electronic device 10 illustrating an embodiment of the present invention. The physical distance defining a gap 19 between the first element 12 and the second element 16 defines a physical separation between elements 12 and 16 allowing translational or rotational movement resulting in vertical scrolling up or down, horizontal motion left or right or selecting content information within the display 14. In addition, a torsional, also called twisting, motion of the second element 16, or first element 12, may be used to scroll up or down within content information of the display 14. For example, twisting of the second element 16 about the center line in a clockwise direction 32 may scroll upward, while twisting the second element 16 in a counterclockwise direction 34 may scroll downward through the content information within the display 14.

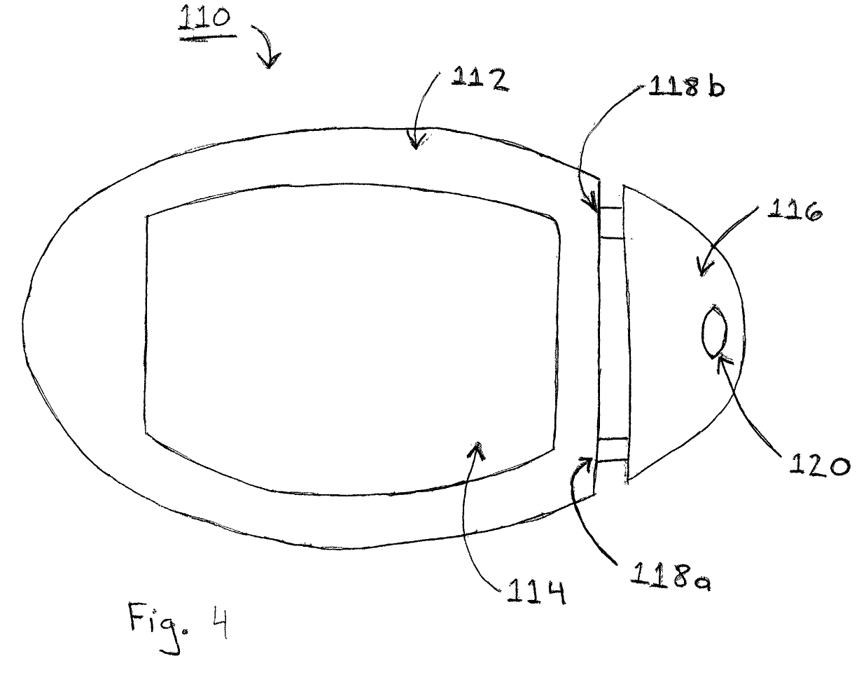

FIG. 4 illustrates an alternative embodiment of the present invention wherein an electronic device 110 comprises a first element 112, a second element 116, a display 114, a first connector 118a, a second connector 118b and a switch 120. First and second connectors 118a and 118b perform the same function as the connector 18 of FIG. 1, and are illustrated to indicate the number and form of connectors is not limited. Switch 120 can be used to select content information within the display 14, and may be placed at any location on either the first element 112 or the second element 116.

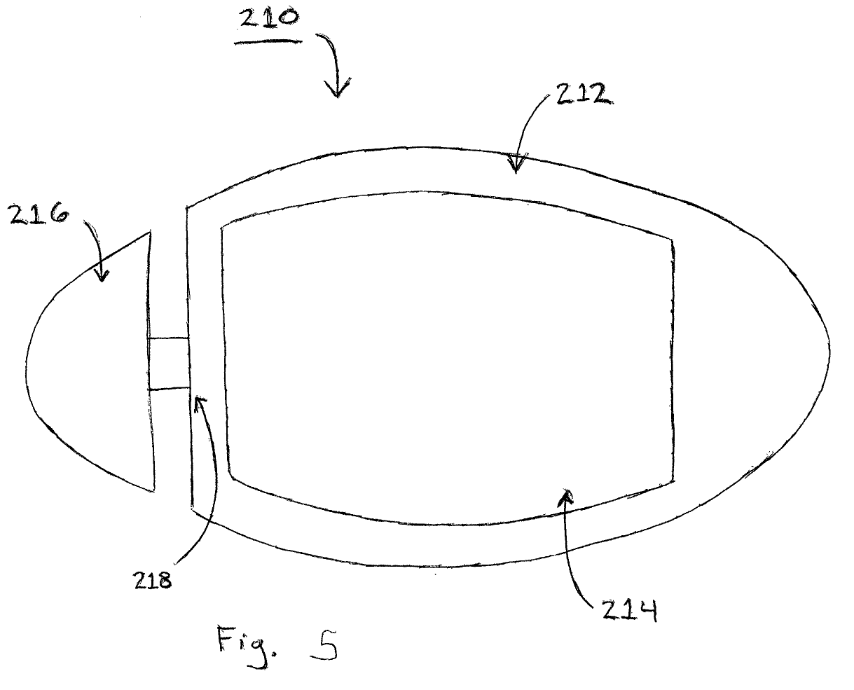

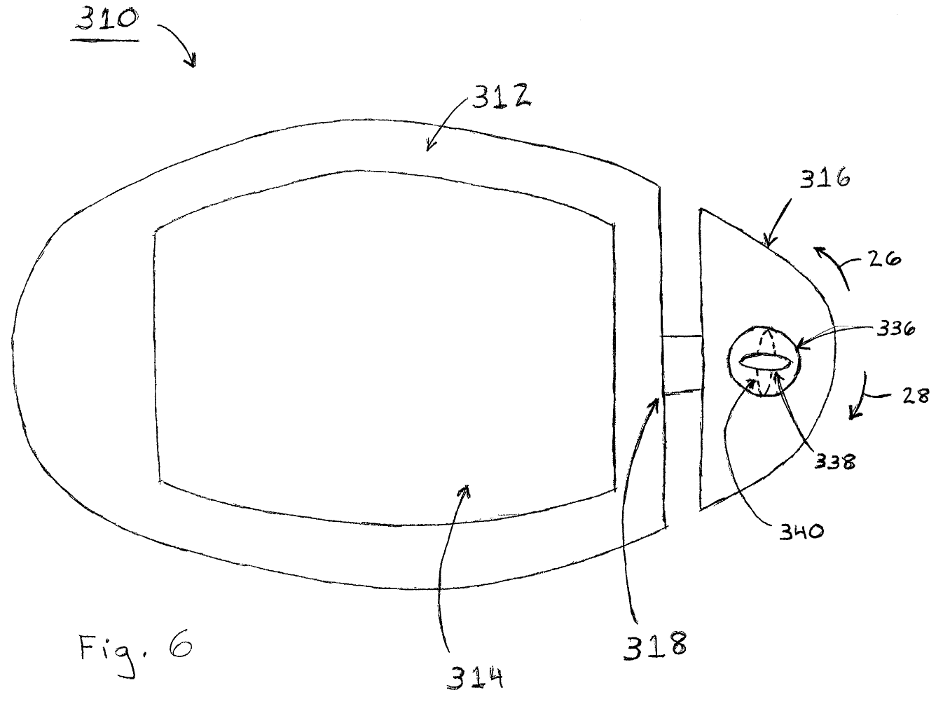

FIG. 5 illustrates a top view of an alternative embodiment of an electronic device 210 of the present invention. The housing for the electronic device 210 comprises a first element 212, a second element 216, a display 214 and a connector 218. The electronic device 210 illustrates locating the second element 216 on the opposite side of the display 214 from that of illustrated in FIG. 2a.

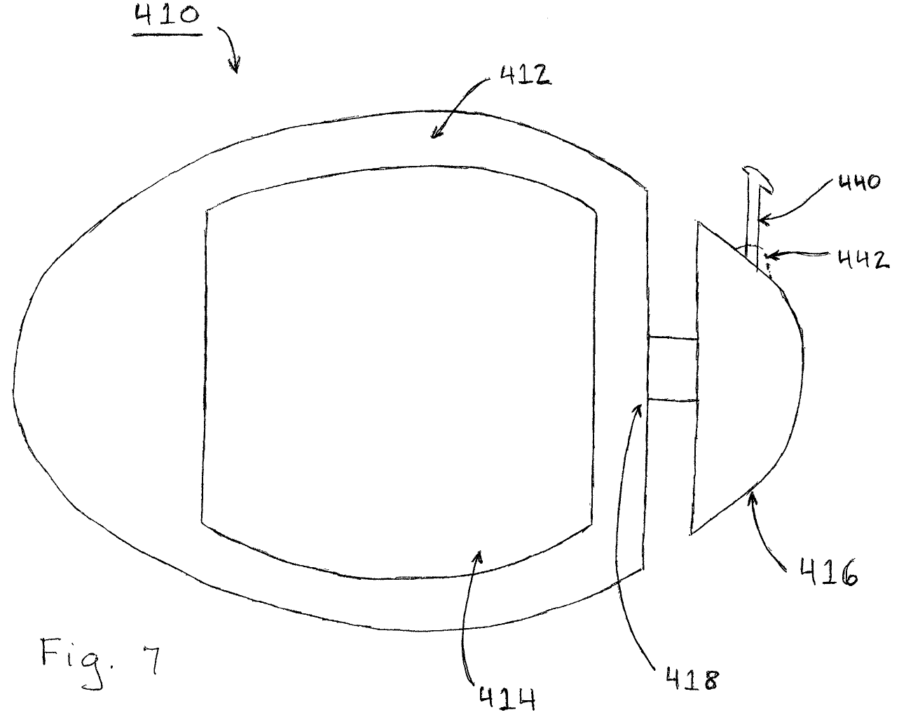

FIG. 6 illustrates another alternative embodiment of an electronic device 310 of the present invention. The housing for electronic device 310 comprises a first element 312, a second element 316, a display 314 and a connector 318. The second element 316 contains a switch 336 having a rotating pointer 338 to direct the direction of scrolling. For example, the rotating pointer 338 is shown in a horizontal position to scroll left and right across the content information within display 314 when the second element 316 is rotated in rotational direction 26 and 28, respectively. When the rotating pointer is in a vertical position 340, rotation of the second element 316 in direction 26 will scroll upward across content information, while movement in direction 28 will scroll downward across content information within display 314.

FIG. 7 illustrates yet another alternative embodiment of an electronic device 410 of the present invention. The housing for the electronic device 410 comprises a first element 412, a second element 416, a display 414 and a connector 418. An extendable controller 440 may be incorporated into the second element 416 to use instead of translational or rotational motion of the second element 416 to scroll through the content information of the display 414. For example, the extendable controller 440 can be used to scroll up, down, left or right by moving the extendable controller in these principal directions. Extendable controller 440 can be placed in retracted position 442 for storage.

It is understood that various modifications can be made to the mobile station apparatus and method of operation and remain within the scope of the present invention. For example, the housing may comprise three or more elements including an external or internal antenna to assist transmission and reception of wireless signals.

While preferred embodiments have been discussed and illustrated above, the present invention is not limited to these descriptions or illustrations, and includes all such modifications, which fall within the scope of the invention and claim language presented below.

What is claimed is:

1. An electronic device having a display for displaying content information wherein the electronic device is capable of operating within a wireless communication system, the electronic device comprising:
a first element and a second element, wherein said first element is coupled to said second element allowing relative motion between said first element and said second element; and
an actuator providing communication between said first element and said second element, wherein said actuator controls the navigation of content information within the display.

2. The electronic device as claimed in claim 1, wherein said actuator operates upon translational motion between said first element and said second element, wherein said navigation is to scroll through content information within the display.

3. The electronic device as claimed in claim 2 further comprising:
a switch located on said first element, said switch in communication with said actuator to select the content information displayed on the display.

4. The electronic device as claimed in claim 2 further comprising:
a switch located on said second element, said switch in communication with said actuator to select the content information displayed on the display.

5. The electronic device as claimed in claim 1, wherein said actuator operates upon rotational movement between said first element and said second element, wherein said navigation is to scroll through content information within the display.

6. The electronic device as claimed in claim 5 further comprising:
a switch located on said first element, said switch in communication with said actuator to select the content information displayed on the display.

7. The electronic device as claimed in claim 5 further comprising:
a switch located on said second element, said switch in communication with said actuator to select the content information displayed on the display.

8. A mobile terminal for operation within a wireless communication system, the mobile terminal comprising:
a major element and a minor element, wherein said major element is coupled to said minor element to permit relative motion between said major element and said minor element;
a display coupled to said major element, wherein said display is for displaying content information;
an actuator providing communication between said major element and said minor element, where said actuator controls scrolling of content information within said display; and
a switch coupled to said minor element, said switch in communication with said actuator to select content information within said display.

9. The electronic device as claimed in claim 8, wherein said actuator operates upon translational motion between said major element and said minor element.

10. The electronic device as claimed in claim 8, wherein said actuator operates upon rotational motion between said major element and said minor element.

11. A method for operation of an electronic device having a display for displaying content information wherein the electronic device is operable within a wireless communication system, the method comprising:
presenting a first element and a second element, wherein said first element is coupled to said second element allowing relative motion between said first element and said second element;
displaying content information on the display;
providing an actuator for providing communication between said first element and said second element, wherein said actuator controls the navigation ofcontent information within the display; and
producing relative motion between said first element and said second element to activate said actuator to scroll through content information within the display.

12. The method as claimed in claim 11, wherein said relative motion involves translational movement between said first element and said second element.

13. The method as claimed in claim 11, wherein said relative motion involves rotational movement between said first element and said second element.

14. The method as claimed in claim 11, wherein said relative motion involves torsional movement between said first element and said second element.

15. A method for scrolling through content information displayed on a display of an electronic device having a first element and a second element, the method comprising the steps of:
receiving input upon user providing a motion of second element in relation to the first element; and
determining a navigational direction through content information based on said input; and
scrolling through the content information based on said navigational direction.

16. The method as claimed in claim 15 wherein said navigational direction is vertical when said motion is translational of the second element in relation to the first element.

17. The method as claimed in claim 15 wherein said navigational direction is horizontal when said motion is translational of the second element in relation to the first element.

18. The method as claimed in claim 15 wherein said navigational direction is vertical when said motion is rotational of the second element in relation to the first element.

19. The method as claimed in claim 15 wherein said navigational direction is horizontal when said motion is rotational of the second element in relation to the first element.
